(19) United States
(12) Patent Application Publication
(10) Pub. No.: US 2020/0082656 A1
(43) Pub. Date: Mar. 12, 2020

(54) FINGERPRINT RECOGNITION AND NFC-BASED UNLOCKING METHOD AND SYSTEM USING MOBILE TERMINAL

(71) Applicant: JRD COMMUNICATION INC., Guangdong (CN)

(72) Inventor: Longxing PAN, Guangdong (CN)

(21) Appl. No.: 16/330,390

(22) PCT Filed: Jul. 18, 2017
(86) PCT No.: PCT/CN2017/093405

§ 371 Date: Mar. 5, 2019

(30) Foreign Application Priority Data
Sep. 5, 2016 (CN) 201610801836.0

(51) Int. Cl. G07C 9/00; H04W 12/06; G06F 16/901; H04B 5/00; G06K 9/00

(52) U.S. Cl. CPC G07C 9/00563; H04W 12/0608; G07C 9/00182; H04W 88/02; H04B 5/0031; G06K 9/001; G06K 9/00926; G06F 16/901

(57) ABSTRACT

A fingerprint recognition and NFC-based unlocking method using a mobile terminal includes: when the mobile terminal approaches an intelligent lock, establishing, by the mobile terminal, a data communication connection to the intelligent lock by means of NFC; sending, by the intelligent lock by means of NFC, an fingerprint authentication instruction to the mobile terminal, and after receiving the instruction from the intelligent lock, displaying, by the mobile terminal, a fingerprint authentication interface on a screen and after receiving a fingerprint input by a user, sending, by the mobile terminal, the fingerprint to the intelligent lock, and comparing, by the intelligent lock, fingerprint information with fingerprint data in a database, where after recognition succeeds, the intelligent lock is unlocked. A fingerprint recognition and NFC-based unlocking system using a mobile terminal is also disclosed.

### BACKGROUND

### Technical Field

The present invention relates to the field intelligent unlocking technologies, and in particular, to a fingerprint recognition and Near Field Communication (NFC)-based unlocking method and system using a mobile terminal.

### Related Art

With rapid development of science and technologies, new technologies are continuously applied to intelligent terminals, for example, the NFC technology and the fingerprint recognition technology, and application of such technologies greatly improves quality and convenience of life of people.

The NFC technology is a short-distance high-frequency radio technology, and runs within a distance of 10 cm at a frequency of 13.56 MHz. The NFC technology has three transmission rates, namely, 106 Kbit/s, 212 Kbit/s, and 424 Kbit/s. The NFC technology is evolved from non-contact radio frequency identification (RFID) and intercommunication and interconnection technologies, an induction-type card reader, an induction-type card, and a point-to-point function are integrated on a single chip, so that identification and data exchange can be performed with a compatible device within a short distance.

The NFC technology has been applied to the field of unlocking. For example, for a room equipped with an intelligent lock at home, a user can approach the intelligent lock with a mobile terminal (such as a mobile phone) carried around to perform unlocking, which is convenient, and it is not needed to carry a lot of keys around. However, any person holding the mobile terminal can unlock such an intelligent lock Consequently, security is not high enough.

Therefore, with regard to the foregoing disadvantages, the prior art still needs to be improved and developed.

### SUMMARY

The technical problem to be resolved by the present invention is to provide, with regard to the foregoing disadvantages in the prior art, a fingerprint recognition and NFC-based unlocking method and system using a mobile terminal, so as to perform intelligent unlocking by means of NFC in combination with the fingerprint recognition technology. When a user performs unlocking with a mobile terminal in hand, the mobile terminal approaches an intelligent lock, and a fingerprint authentication interface pops up on an interface of the mobile terminal, to prompt the user to input a fingerprint of the user. The mobile terminal sends the collected fingerprint by means of NFC to the intelligent lock, the intelligent lock compares the obtained fingerprint data with preset fingerprint data in a database for recognition, and when the database includes the fingerprint data, the intelligent lock is unlocked. Not only convenience is brought for the user to perform unlocking, but also security is improved.

The technical problems are resolved by the present invention by using the following technical solutions:

A fingerprint recognition and NFC-based unlocking method using a mobile terminal is provided, including:

step A: when the mobile terminal approaches an intelligent lock, establishing, by the mobile terminal, a data communication connection to the intelligent lock by means of NFC;

step B: sending, by the intelligent lock by means of NFC, an fingerprint authentication instruction to the mobile terminal, and after receiving the instruction from the intelligent lock, displaying, by the mobile terminal, a fingerprint authentication interface on a screen; and

step C: after receiving a fingerprint input by a user, sending, by the mobile terminal by means of NFC, the fingerprint to the intelligent lock, and comparing, by the intelligent lock, received fingerprint information with fingerprint data in a database, where after recognition succeeds, the intelligent lock is unlocked.

In the fingerprint recognition and NFC-based unlocking method using a mobile terminal, before the step A, the method further includes:

step S: when the mobile terminal establishes an NFC connection to the intelligent lock for a first time, setting an initial password of the intelligent lock by means of an intelligent unlocking application on the mobile terminal, and after a fingerprint of a user is recorded by means of the intelligent unlocking application, storing the fingerprint into a database of a storage module of the intelligent lock.

In the fingerprint recognition and NFC-based unlocking method using a mobile terminal, the initial password includes 16 character strings, the character strings include a digit, a letter, and an underline, the initial password is used for changing an intelligent lock password and changing fingerprint information in the database of the intelligent lock, and after the password is successfully set, a fingerprint of an authorized person can be added by the user to the database of the storage module of the intelligent lock.

In the fingerprint recognition and NFC-based unlocking method using a mobile terminal, the step A specifically includes:

A1: when the mobile terminal approaches the intelligent lock, performing data communication after an NFC module in the mobile terminal is paired with and connected to an NFC module in the intelligent lock; and

A2: after establishment of communication is completed, sending, by the mobile terminal by means of NFC, a command for unlocking the intelligent lock to the intelligent lock.

In the fingerprint recognition and NFC-based unlocking method using a mobile terminal, the step B specifically includes:

B1: after receiving the command for unlocking the intelligent lock sent by the mobile terminal, sending, by the intelligent lock by means of NFC, the fingerprint authentication instruction to the mobile terminal; and

B2: after the mobile terminal receives the fingerprint authentication instruction sent by the intelligent lock, displaying, by a mobile terminal system by means of the intelligent unlocking application, the fingerprint authentication interface on the screen of the mobile terminal, to prompt the user to input a fingerprint for authentication.

In the fingerprint recognition and NFC-based unlocking method using a mobile terminal, the step C specifically includes:

C1: after receiving the fingerprint input by the user, sending, by the mobile terminal by means of NFC, the fingerprint to the intelligent lock, and comparing, by the intelligent lock, the received fingerprint information with the fingerprint data in the database of the storage module, and determining whether the fingerprint information exists in the database of the storage module; and

C2: when the fingerprint information exists in the database of the storage module of the intelligent lock, indicating recognition succeeds, unlocking the intelligent lock, and when comparison of the fingerprint information continuously fails for three times, informing the user of an unlocking failure and that the user needs to wait for a predetermined time before performing unlocking again.

A fingerprint recognition and NFC-based unlocking system using a mobile terminal is provided, including:

a presetting module, configured to: when the mobile terminal establishes an NFC connection to an intelligent lock for a first time, set an initial password of the intelligent lock by means of an intelligent unlocking application on the mobile terminal, and after a fingerprint of a user is recorded by means of the intelligent unlocking application, store the fingerprint into a database of a storage module of the intelligent lock;

a communication connection module, configured to: when the mobile terminal approaches the intelligent lock, control the mobile terminal to establish a data communication connection to the intelligent lock by means of NFC;

a fingerprint authentication module, configured to control the intelligent lock to send a fingerprint authentication instruction by means of NFC to the mobile terminal, where after receiving the instruction from the intelligent lock, the mobile terminal displays a fingerprint authentication interface on a screen; and

a comparison and recognition module, configured to: after the mobile terminal receives the fingerprint input by the user, send the fingerprint to the intelligent lock by means of NFC, where the intelligent lock compares received fingerprint information with fingerprint data in the database, and after recognition succeeds, the intelligent lock is unlocked.

In the fingerprint recognition and NFC-based unlocking system using a mobile terminal, the communication connection module specifically includes:

a connection and pairing unit, configured to: when the mobile terminal approaches the intelligent lock, perform data communication after controlling an NFC module in the mobile terminal to be paired with and connected to an NFC module in the intelligent lock; and

an unlocking command sending unit, configured to after establishment of communication is completed, control the mobile terminal to send, by means of NFC, a command for unlocking the intelligent lock to the intelligent lock.

In the fingerprint recognition and NFC-based unlocking system using a mobile terminal, the fingerprint authentication module specifically includes:

an authentication instruction sending unit, configured to: after the intelligent lock receives the command for unlocking the intelligent lock sent by the mobile terminal, control the intelligent lock to send the fingerprint authentication instruction to the mobile terminal by means of NFC; and

an authentication prompting unit, configured to: after the mobile terminal receives the fingerprint authentication instruction sent by the intelligent lock, control a mobile terminal system to display the fingerprint authentication interface on the screen of the mobile terminal by means of the intelligent unlocking application, to prompt a user to input a fingerprint for authentication.

In the fingerprint recognition and NFC-based unlocking system using a mobile terminal, the comparison and recognition module specifically includes:

a comparison and determining unit, configured to: after the mobile terminal receives the fingerprint input by the user, send the fingerprint to the intelligent lock by means of NFC, where the intelligent lock compares the received fingerprint information with the fingerprint data in the database of the storage module, and determines whether the fingerprint information exists in the database of the storage module; and

a recognition failure handling unit, configured to: when the fingerprint information exists in the database of the storage module of the intelligent lock, indicating a recognition success, unlock the intelligent lock, and when comparison of the fingerprint information continuously fails for three times, inform the user of an unlocking failure and that the user needs to wait for a predetermined time before performing unlocking again.

The present invention discloses a fingerprint recognition and NFC-based unlocking method using a mobile terminal, including: when a mobile terminal approaches an intelligent lock, establishing, by the mobile terminal, a data communication connection to the intelligent lock by means of NFC; sending, by the intelligent lock by means of NFC, an fingerprint authentication instruction to the mobile terminal, and after receiving the instruction from the intelligent lock, displaying, by the mobile terminal, a fingerprint authentication interface on a screen; and after receiving a fingerprint input by a user, sending, by the mobile terminal by means of NFC, the fingerprint to the intelligent lock, and comparing, by the intelligent lock, received fingerprint information with fingerprint data in a database, where after recognition succeeds, the intelligent lock is unlocked. In the present invention, intelligent unlocking is performed by means of NFC in combination with fingerprint recognition. When a user performs unlocking with a mobile terminal in hand, the mobile terminal approaches an intelligent lock, and a fingerprint authentication interface pops up on an interface of the mobile terminal, to prompt the user to input a fingerprint of the user. The mobile terminal sends the collected fingerprint by means of NFC to the intelligent lock, the intelligent lock compares the obtained fingerprint data with preset fingerprint data in a database for recognition, and when the database includes the fingerprint data, the intelligent lock is unlocked. Not only convenience is brought for the user to perform unlocking, but also security is improved.

### BRIEF DESCRIPTION OF THE DRAWINGS

FIG. 1 is a flowchart of a preferred embodiment of a fingerprint recognition and NFC-based unlocking method using a mobile terminal according to the present invention;

FIG. 2 is a flowchart of a specific embodiment of a fingerprint recognition and NFC-based unlocking method using a mobile terminal according to the present invention; and

FIG. 3 is a block diagram of a function principle of a preferred embodiment of a fingerprint recognition and NFC-based unlocking system using a mobile terminal according to the present invention.

### DETAILED DESCRIPTION

In order to make the objectives, technical solutions, and advantages of the present invention more comprehensible and clearer, the present invention is described in further detail below by describing embodiments with reference to the accompanying drawings. It should be understood that the specific embodiments described herein are merely used to explain the present invention rather than limit the present invention.

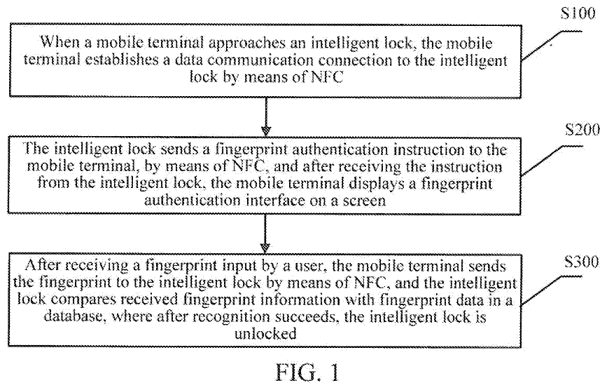

Referring to FIG. 1, FIG. 1 is a flowchart of a preferred embodiment of a fingerprint recognition and NFC-based unlocking method using a mobile terminal according to the present invention.

As shown in FIG. 1, this embodiment of the present invention provides a specific embodiment of a fingerprint recognition and NFC-based unlocking method using a mobile terminal, including the following steps.

Step S100: When the mobile terminal approaches an intelligent lock, the mobile terminal establishes a data communication connection to the intelligent lock by means of NFC.

In the present invention, before the step S100, the method further includes: when the mobile terminal establishes an NFC connection to the intelligent lock for a first time, setting an initial password of the intelligent lock by means of an intelligent unlocking application on the mobile terminal, and after a fingerprint of a user is recorded by means of the intelligent unlocking application, storing the fingerprint into a database of a storage module of the intelligent lock.

That is, when a user unlocks an intelligent lock having an NFC module by using a mobile terminal having an NFC module for a first time, for the purpose of security, and meanwhile, because the intelligent lock did not save fingerprint data of the user, it is needed to preset an initial password for the intelligent lock, and setting on the initial password is performed by means of an intelligent unlocking application (software) on the mobile terminal. When setting of the password is completed, it is also needed to record a fingerprint of a user by means of the intelligent unlocking application, and the fingerprint data recorded by the mobile terminal is sent by means of NFC to the database of the storage module of the intelligent lock for storage, so as to facilitate subsequently performing fingerprint comparison when the user performs unlocking by means of fingerprint recording.

The initial password includes 16 character strings, and the character strings include a digit, a letter, and an underline. For example, the password may be set to “123456abcdef_ _ _ _”. Certainly, the password may be a combination made by a user according to a remembering habit and common characters. The initial password is used for changing the intelligent lock password and changing fingerprint information in the database of the intelligent lock. After the password is successfully set, a fingerprint of a authorized person can be added by the user to the database of the storage module of the intelligent lock. For example, if all of family members need to unlock an intelligent lock of a door, fingerprint data of other family members may be added to the database of the intelligent lock by a user who first starts to have the fingerprint recorded by means of the initial password. After information of the other members is successfully recorded, unlocking can also be performed in a fingerprint authentication manner.

The step S100 specifically includes: when the mobile terminal approaches the intelligent lock, performing data communication after an NFC module in the mobile terminal is paired with and connected to an NFC module in the intelligent lock; and after establishment of communication is completed, sending, by the mobile terminal by means of NFC, a command for unlocking the intelligent lock to the intelligent lock.

Step S200: The intelligent lock sends a fingerprint authentication instruction to the mobile terminal, by means of NFC, and after receiving the instruction from the intelligent lock, the mobile terminal displays a fingerprint authentication interface on a screen.

In the present invention, the step S200 specifically includes: after receiving the command for unlocking the intelligent lock sent by the mobile terminal, sending, by the intelligent lock by means of NFC, the fingerprint authentication instruction to the mobile terminal; and after the mobile terminal receives the fingerprint authentication instruction sent by the intelligent lock, displaying, by a mobile terminal system by means of the intelligent unlocking application, the fingerprint authentication interface on the screen of the mobile terminal, to prompt the user to input a fingerprint for authentication.

When the intelligent lock into which the fingerprint data of the user has been recorded is unlocked, if the user approaches the intelligent lock with the mobile terminal in hand, the intelligent lock senses an instruction indicating that the user needs to perform unlocking, and the intelligent lock immediately sends the fingerprint authentication instruction to the mobile terminal by means of NFC, after receiving the instruction from the intelligent lock, the mobile terminal displays a fingerprint authentication interface (this function is implemented by the intelligent unlocking application installed on the mobile terminal) on the screen of the mobile terminal, to prompt the user to input a fingerprint of the user within 10 seconds.

Step S300: After receiving a fingerprint input by a user, the mobile terminal sends the fingerprint to the intelligent lock by means of NFC, and the intelligent lock compares received fingerprint information with fingerprint data in the database, where after recognition succeeds, the intelligent lock is unlocked.

The fingerprint recognition technology is performing authentication based on texture lines generated by rough and uneven surfaces on the front skin of tips of fingers of a person and has the following main advantages: fingerprints are unique features of human bodies, and complexity of the fingerprints is enough to provide sufficient features for authentication; if it is needed to increase reliability, it is only needed to register more fingerprints, and authentication is performed on more fingers, up to ten fingers, and each fingerprint is unique; a speed of scanning a fingerprint is fast, and use is very convenient; when a fingerprint is read, the user needs to get the finger in contact with a fingerprint acquisition head, and direct contact between the finger and the fingerprint acquisition head is the most reliable method for reading a biological feature of a human body. Therefore, on the basis of performing unlocking by means of NFC, in the present invention, unlocking is performed after performing authentication by means of fingerprint recognition, and security of intelligent unlocking is effectively improved.

In the present invention, the step S300 specifically includes: after receiving the fingerprint input by the user, sending, by the mobile terminal by means of NFC, the fingerprint to the intelligent lock, and comparing, by the intelligent lock, the received fingerprint information with the fingerprint data in the database of the storage module, and determining whether the fingerprint information exists in the database of the storage module, where provided that the user has recorded the fingerprint data in to the database of the storage module of the intelligent lock in advance, recognition succeeds after the fingerprint is input, and the intelligent lock is further unlocked. That is, when the fingerprint information exists in the database of the intelligent lock storage module, the recognition succeeds, and the intelligent lock is unlocked. To avoid an error during fingerprint recognition, three fingerprint recognition opportunities are provided, usually, for a fingerprint that has been recorded, three times can enable the user to unlock the intelligent lock. However, when comparison of the fingerprint information continuously fails for three times, the fingerprint may be not a fingerprint of the user, and there is a risk of burglary, the user is informed of an unlocking failure and that the user needs to wait for a predetermined time before performing unlocking again. Moreover, the predetermined time may be set by the user according to actual requirements, and is, preferably, 24 hours.

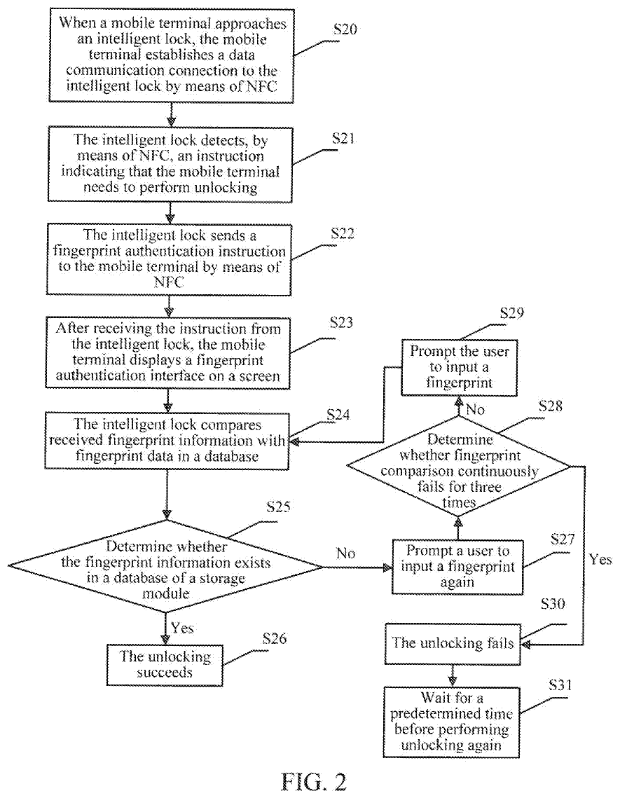

To make the fingerprint recognition and NFC-based unlocking method by using a mobile terminal more comprehensible, a procedure of a specific embodiment is provided below. Referring to FIG. 2, FIG. 2 is a flowchart of a specific embodiment of a fingerprint recognition and NFC-based unlocking method using a mobile terminal according to the present invention.

As shown in FIG. 2, the procedure of the specific embodiment includes:

S20: When the mobile terminal approaches an intelligent lock, the mobile terminal establishes a data communication connection to the intelligent lock by means of NFC.

S21: The intelligent lock detects, by means of NFC, an instruction indicating that the mobile terminal needs to perform unlocking.

S22: The intelligent lock sends a fingerprint authentication instruction to the mobile terminal by means of NFC.

S23: After receiving the instruction from the intelligent lock, the mobile terminal displays a fingerprint authentication interface on a screen.

S24: A user inputs a fingerprint, the mobile terminal sends fingerprint information to the intelligent lock by means of NFC, and the intelligent lock compares the received fingerprint information with fingerprint data in the database.

S25: Determine whether the fingerprint information exists in a database of a storage module.

S26: If the fingerprint information exists in a database of a storage module of the intelligent lock, indicating a recognition success, unlock the intelligent lock.

S27: If the fingerprint information does not exist in the database of the storage module of the intelligent lock, prompt the user to input a fingerprint again.

S28: Determine whether fingerprint comparison continuously fails for three times, and if yes, perform S30; otherwise, perform S29.

S29: If fingerprint determining is continuously performed less than three times, prompt the user to input a fingerprint again, and go back to S24 to continue to perform other steps.

S30: If fingerprint comparison continuously fails for three times, the unlocking fails.

S31: When comparison of the fingerprint information continuously fails for three times, inform the user of an unlocking failure and that the user needs to wait for a predetermined time before performing unlocking again.

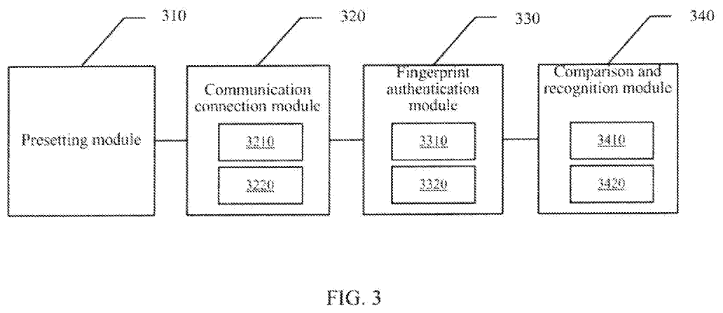

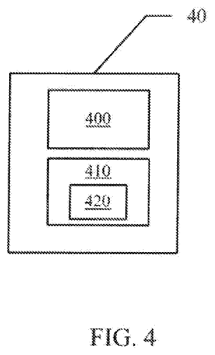

Based on the foregoing embodiments, the present invention further provides a fingerprint recognition and NFC-based unlocking system using a mobile terminal. Referring to FIG. 3, FIG. 3 is a block diagram of a function principle of a preferred embodiment of a fingerprint recognition and NFC-based unlocking system using a mobile terminal according to the present invention.

As shown in FIG. 3, the system includes the following modules.

A presetting module 310 is configured to: when the mobile terminal establishes an NFC connection to an intelligent lock for a first time, set an initial password of the intelligent lock by means of an intelligent unlocking application on the mobile terminal, and after a fingerprint of a user is recorded by means of the intelligent unlocking application, store the fingerprint into a database of a storage module of the intelligent lock. Details are described above.

A communication connection module 320 is configured to: when the mobile terminal approaches the intelligent lock, control the mobile terminal to establish a data communication connection to the intelligent lock by means of NFC. Details are described above.

A fingerprint authentication module 330 is configured to control the intelligent lock to send a fingerprint authentication instruction by means of NFC to the mobile terminal, where after receiving the instruction from the intelligent lock, the mobile terminal displays a fingerprint authentication interface on a screen. Details are described above.

A comparison and recognition module 340 is configured to: after the mobile terminal receives the fingerprint input by the user, send the fingerprint to the intelligent lock by means of NFC, where the intelligent lock compares received fingerprint information with fingerprint data in the database, and after recognition succeeds, the intelligent lock is unlocked. Details are described above.

Further, in the fingerprint recognition and NFC-based unlocking system using a mobile terminal, the communication connection module specifically includes the following units.

A connection and pairing unit is configured to: when the mobile terminal approaches the intelligent lock, perform data communication after controlling an NFC module in the mobile terminal to be paired with and connected to an NFC module in the intelligent lock. Details are described above.

An unlocking command sending unit is configured to after establishment of communication is completed, control the mobile terminal to send, by means of NFC, a command for unlocking the intelligent lock to the intelligent lock. Details are described above.

In the fingerprint recognition and NFC-based unlocking system using a mobile terminal, the fingerprint authentication module specifically includes the following units.

An authentication instruction sending unit is configured to: after the intelligent lock receives the command for unlocking the intelligent lock sent by the mobile terminal, control the intelligent lock to send the fingerprint authentication instruction to the mobile terminal by means of NFC. Details are described above.

An authentication prompting unit is configured to: after the mobile terminal receives the fingerprint authentication instruction sent by the intelligent lock, control a mobile terminal system to display the fingerprint authentication interface on the screen of the mobile terminal by means of the intelligent unlocking application, to prompt a user to input a fingerprint for authentication. Details are described above.

In the fingerprint recognition and NFC-based unlocking system using a mobile terminal, the comparison and recognition module specifically includes the following units.

A comparison and determining unit is configured to: after the mobile terminal receives the fingerprint input by the user, send the fingerprint to the intelligent lock by means of NFC, where the intelligent lock compares the received fingerprint information with the fingerprint data in the database of the storage module, and determines whether the fingerprint information exists in the database of the storage module. Details are described above.

A recognition failure handling unit is configured to: when the fingerprint information exists in the database of the storage module of the intelligent lock, indicating a recognition success, unlock the intelligent lock, and when comparison of the fingerprint information continuously fails for three times, inform the user of an unlocking failure and that the user needs to wait for a predetermined time before performing unlocking again. Details are described above.

In conclusion, the present invention discloses a fingerprint recognition and NFC-based unlocking method using a mobile terminal, including: when a mobile terminal approaches an intelligent lock, establishing, by the mobile terminal, a data communication connection to the intelligent lock by means of NFC; sending, by the intelligent lock by means of NFC, an fingerprint authentication instruction to the mobile terminal, and after receiving the instruction from the intelligent lock, displaying, by the mobile terminal, a fingerprint authentication interface on a screen; and after receiving a fingerprint input by a user, sending, by the mobile terminal by means of NFC, the fingerprint to the intelligent lock, and comparing, by the intelligent lock, received fingerprint information with fingerprint data in a database, where after recognition succeeds, the intelligent lock is unlocked. In the present invention, intelligent unlocking is performed by means of NFC in combination with fingerprint recognition. When a user performs unlocking with a mobile terminal in hand, the mobile terminal approaches an intelligent lock, and a fingerprint authentication interface pops up on an interface of the mobile terminal, to prompt the user to input a fingerprint of the user. The mobile terminal sends the collected fingerprint by means of NFC to the intelligent lock, the intelligent lock compares the obtained fingerprint data with preset fingerprint data in a database for recognition, and when the database includes the fingerprint data, the intelligent lock is unlocked. Not only convenience is brought for the user to perform unlocking, but also security is improved.

Certainly, a person of ordinary skill in the art should understand that all or some of the steps of the method according to the foregoing embodiments may be implemented by a program instructing relevant hardware (such as a processor or a controller). The program may be stored in a computer readable storage medium. When the program is run, the steps of the embodiments of the method may be included. The storage medium may be a memory, a magnetic disk, an optical disc, or the like.

It should be understood that the application of the present invention is not limited to the foregoing examples. A person of ordinary skill in the art may make improvements or modifications according to the foregoing description, and all of the improvements and modifications should all fall within the protection scope of the attached claims of the present invention.

1. A fingerprint recognition and near field communication (NFC)-based unlocking method using a mobile terminal, comprising:
step A: when the mobile terminal approaches an intelligent lock, establishing, by the mobile terminal, a data communication connection to the intelligent lock by means of NFC;
step B: sending, by the intelligent lock by means of NFC, a fingerprint authentication instruction to the mobile terminal, and after receiving the instruction from the intelligent lock, displaying, by the mobile terminal, a fingerprint authentication interface on a screen, wherein the step B comprises:
B1: after receiving a command for unlocking the intelligent lock sent by the mobile terminal, the intelligent lock sends the fingerprint authentication instruction to the mobile terminal by means of NFC; and
B2: after the mobile terminal receives the fingerprint authentication instruction sent by the intelligent lock, a mobile terminal system displays the fingerprint authentication interface on the screen of the mobile terminal by means of the intelligent unlocking application, to prompt a user to input a fingerprint for authentication; and
step C: after receiving the fingerprint input by the user, sending, by the mobile terminal by means of NFC, the fingerprint to the intelligent lock, and comparing, by the intelligent lock, received fingerprint information with fingerprint data in a database, wherein after recognition succeeds the intelligent lock is unlocked, wherein the step C comprises:
C1: after receiving the fingerprint input by the user, the mobile terminal sends the fingerprint to the intelligent lock by means of NFC, and the intelligent lock compares the received fingerprint information with the fingerprint data in the database of a storage module, and determines whether the fingerprint information exists in the database of the storage module; and
C2: when the fingerprint information exists in the database of the storage module of the intelligent lock, the recognition succeeds, and the intelligent lock is unlocked, and when comparison of the fingerprint information continuously fails for three times, the user is informed of an unlocking failure and that the user needs to wait for a predetermined time before performing unlocking again.

2. The fingerprint recognition and NFC-based unlocking method using the mobile terminal according to claim 1, wherein before the step A, the method further comprises:
step S: when the mobile terminal establishes an NFC connection to the intelligent lock for a first time, setting an initial password of the intelligent lock by means of an intelligent unlocking application on the mobile terminal, and after a fingerprint of a user is recorded by means of the intelligent unlocking application, storing the fingerprint into a database of a storage module of the intelligent lock.

3. The fingerprint recognition and NFC-based unlocking method using the mobile terminal according to claim 2, wherein the initial password comprises 16 character strings, the character strings comprise a digit, a letter, and an underline, the initial password is used for changing an intelligent lock password and changing fingerprint information in the database of the intelligent lock, and after the password is successfully set, a fingerprint of an authorized person can be added by the user to the database of the storage module of the intelligent lock.

4. The fingerprint recognition and NFC-based unlocking method using the mobile terminal according to claim 1, wherein the step A comprises:
A1: when the mobile terminal approaches the intelligent lock, performing data communication after an NFC module in the mobile terminal is paired with and connected to an NFC module in the intelligent lock; and
A2: after establishment of communication is completed, sending, by the mobile terminal by means of NFC, a command for unlocking the intelligent lock to the intelligent lock.

5. A fingerprint recognition and near field communication (NFC)-based unlocking method using a mobile terminal, comprising:
step A: when the mobile terminal approaches an intelligent lock, establishing, by the mobile terminal, a data communication connection to the intelligent lock by means of NFC;
step B: sending, by the intelligent lock by means of NFC, a fingerprint authentication instruction to the mobile terminal, and after receiving the instruction from the intelligent lock, displaying, by the mobile terminal, a fingerprint authentication interface on a screen; and
step C: after receiving a fingerprint input by a user, sending, by the mobile terminal by means of NFC, the fingerprint to the intelligent lock, and comparing, by the intelligent lock, received fingerprint information with fingerprint data in a database, wherein after recognition succeeds, the intelligent lock is unlocked.

6. The fingerprint recognition and NFC-based unlocking method using the mobile terminal according to claim 5, wherein before the step A, the method further comprises:
step S: when the mobile terminal establishes an NFC connection to the intelligent lock for a first time, setting an initial password of the intelligent lock by means of an intelligent unlocking application on the mobile terminal, and after a fingerprint of a user is recorded by means of the intelligent unlocking application, storing the fingerprint into a database of a storage module of the intelligent lock.

7. The fingerprint recognition and NFC-based unlocking method using the mobile terminal according to claim 6, wherein the initial password comprises 16 character strings, the character strings comprise a digit, a letter, and an underline, the initial password is used for changing an intelligent lock password and changing fingerprint information in the database of the intelligent lock, and after the password is successfully set, a fingerprint of an authorized person can be added by the user to the database of the storage module of the intelligent lock.

8. The fingerprint recognition and NFC-based unlocking method using the mobile terminal according to claim 5, wherein the step A comprises:
A1: when the mobile terminal approaches the intelligent lock, performing data communication after an NFC module in the mobile terminal is paired with and connected to an NFC module in the intelligent lock; and
A2: after establishment of communication is completed, sending, by the mobile terminal by means of NFC, a command for unlocking the intelligent lock to the intelligent lock.

9. The fingerprint recognition and NFC-based unlocking method using the mobile terminal according to claim 5, wherein the step B comprises:
B1: after receiving the command for unlocking the intelligent lock sent by the mobile terminal, sending, by the intelligent lock by means of NFC, the fingerprint authentication instruction to the mobile terminal; and
B2: after the mobile terminal receives the fingerprint authentication instruction sent by the intelligent lock, displaying, by a mobile terminal system by means of the intelligent unlocking application, the fingerprint authentication interface on the screen of the mobile terminal, to prompt the user to input a fingerprint for authentication.

10. The fingerprint recognition and NFC-based unlocking method using the mobile terminal according to claim 5, wherein the step C comprises:
C1: after receiving the fingerprint input by the user, sending, by the mobile terminal by means of NFC, the fingerprint to the intelligent lock, and comparing, by the intelligent lock, the received fingerprint information with the fingerprint data in the database of a storage module, and determining whether the fingerprint information exists in the database of the storage module; and
C2: when the fingerprint information exists in the database of the storage module of the intelligent lock, indicating recognition succeeds, unlocking the intelligent lock, and when comparison of the fingerprint information continuously fails for three times, informing the user of an unlocking failure and that the user needs to wait for a predetermined time before performing unlocking again.

11. A fingerprint recognition and near field communication (NFC)-based unlocking system using a mobile terminal, comprising:
at least one processor;
at least one memory; and
at least one program instruction stored in the at least one memory to perform, when executed by the processor, the following operations of:
setting an initial password of the intelligent lock by means of an intelligent unlocking application on the mobile terminal when the mobile terminal establishes an NFC connection to an intelligent lock for a first time, and storing the fingerprint into a database of a storage module of the intelligent lock after a fingerprint of a user is recorded by means of the intelligent unlocking application,
controlling the mobile terminal to establish a data communication connection to the intelligent lock by means of NFC when the mobile terminal approaches the intelligent lock;
controlling the intelligent lock to send a fingerprint authentication instruction by means of NFC to the mobile terminal, wherein after receiving the instruction from the intelligent lock, the mobile terminal displays a fingerprint authentication interface on a screen; and
sending the fingerprint to the intelligent lock by means of NFC after the mobile terminal receives the fingerprint input by the user, wherein the intelligent lock compares received fingerprint information with fingerprint data in the database, and after recognition succeeds, the intelligent lock is unlocked.

12. The fingerprint recognition and NFC-based unlocking system using the mobile terminal according to claim 11, wherein the controlling the mobile terminal to establish the data communication connection to the intelligent lock by means of NFC comprises:
performing data communication after controlling an NFC module in the mobile terminal to be paired with and connected to an NFC module in the intelligent lock, when the mobile terminal approaches the intelligent lock; and
controlling the mobile terminal to send, by means of NFC, a command for unlocking the intelligent lock to the intelligent lock after establishment of communication is completed.

13. The fingerprint recognition and NFC-based unlocking system using the mobile terminal according to claim 11, wherein the controlling the intelligent lock to send the fingerprint authentication instruction by means of NFC to the mobile terminal comprises:
controlling the intelligent lock to send the fingerprint authentication instruction to the mobile terminal by means of NFC after the intelligent lock receives the command for unlocking the intelligent lock sent by the mobile terminal; and
controlling a mobile terminal system to display the fingerprint authentication interface on the screen of the mobile terminal by means of the intelligent unlocking application, to prompt a user to input a fingerprint for authentication after the mobile terminal receives the fingerprint authentication instruction sent by the intelligent lock.

14. The fingerprint recognition and NFC-based unlocking system using the mobile terminal according to claim 13, wherein the controlling the mobile terminal system to display the fingerprint authentication interface on the screen of the mobile terminal by means of the intelligent unlocking application prompts the user to input a fingerprint within 10 seconds for authentication.

15. The fingerprint recognition and NFC-based unlocking system using the mobile terminal according to claim 11, wherein the sending the fingerprint to the intelligent lock by means of NFC comprises:
sending the fingerprint to the intelligent lock by means of NFC after the mobile terminal receives the fingerprint input by the user, wherein the intelligent lock compares the received fingerprint information with the fingerprint data in the database of the storage module, and determines whether the fingerprint information exists in the database of the storage module; and
indicating a recognition success and unlocking the intelligent lock when the fingerprint information exists in the database of the storage module of the intelligent lock, and informing the user of an unlocking failure and that the user needs to wait for a predetermined time before performing unlocking again when comparison of the fingerprint information continuously fails for three times.

16. The fingerprint recognition and NFC-based unlocking system using the mobile terminal according to claim 15, wherein the predetermined time that needs to be waited for is 24 hours.

17. The fingerprint recognition and NFC-based unlocking system using the mobile terminal according to claim 11, wherein the initial password is used for changing an intelligent lock password and changing fingerprint information in the database of the intelligent lock, and after the password is successfully set, a fingerprint of an authorized person can be added by the user to the database of the storage module of the intelligent lock.

18. The fingerprint recognition and NFC-based unlocking system using the mobile terminal according to claim 17, wherein the initial password comprises 16 character strings, and the character strings comprise a digit, a letter, and an underline.
